(19) United States
(12) Patent Application Publication
(10) Pub. No.: US 2013/0035892 A1
(43) Pub. Date: Feb. 7, 2013

(54) APPARATUS, METHOD AND COMPUTER PROGRAM PRODUCT FOR TESTING PROCESSING ELECTRONICS

(71) Applicant: Dieter Gallein, Eggolsheim (DE)

(72) Inventor: Dieter Gallein, Eggolsheim (DE)

(73) Assignee: SIEMENS AKTIENGESELLSCHAFT, Munich (DE)

(21) Appl. No.: 13/557,642

(22) Filed: Jul. 25, 2012

(30) Foreign Application Priority Data
Aug. 1, 2011 (DE) 102011080189.8

(51) Int. Cl. G06F 19/00

(52) U.S. Cl. 702/123

(57) ABSTRACT

An apparatus and method are disclosed for testing processing electronics, especially a detector module of a computer tomograph. In at least one embodiment, the apparatus includes at least one processing center, which defines test sequences during operation and/or further processes result data from the test sequences; a scheduler unit connected to the processing center which during operation, after accepting definitions of the test sequences from the processing center, executes these test sequences independently and which is coupled to a contact apparatus for contacting the processing electronics; a signal generator, which initiates test signals at the processing logic; and at least one trigger unit which during operation, synchronizes a start of a test sequence executed by the scheduler unit and an initiation of the test signals by the signal generator in real time with one another.

### PRIORITY STATEMENT

The present application hereby claims priority under 35 U.S.C. §119 to German patent application number DE 102011080189.8 filed Aug. 1, 2011, the entire contents of which are hereby incorporated herein by reference.

### FIELD

The present invention generally relates to an apparatus and/or a method for testing processing electronics, especially an integrated circuit of a detector module of a computer tomograph, i.e. embodied so that such a detector module can be tested therewith.

### BACKGROUND

Detector modules of computer tomographs mostly comprise a plurality of detector elements, the processing electronics of which is to be examined in respect of its quality before a detector is installed. The testing or qualification of processing electronics, especially of detector amplifiers, especially of analog-digital detector amplifiers, requires a measurement or test environment that is as low-noise as possible (the terms measurement and testing are generally used synonymously here), which minimize corruptions of the characteristics of these high-resolution detector amplifiers as much as possible. Thus for example, noise, drift and linearity errors as well as errors in other parameters are preferably kept so small by the testing environment that they are as negligible as possible.

An apparatus for testing such processing electronics is disclosed in DE 10 2004 050 615 A1. The processing electronics is tested here by a test current generation device, which issues a test current to the processing electronics to be tested. The signals generated herefrom by the processing electronics are tapped off by a tapping-off apparatus and evaluated with the aid of a downstream measurement and evaluation apparatus.

In such an arrangement the detector amplifiers of the detector are thus stimulated on the input side by way of a power source and an output signal of the processing electronics is either converted from analog to digital or is already present in digital form. The corresponding output signal of the processing electronics is read in and processed by measurement devices or computers. In such cases measurement or test data is computed and the results are presented in tabular or graphical form for example.

A commercially-available device such as that made by Keithley, model 6430, Sub-Femtoamp Remote SourceMeter, can be used for example as the power source or test current generation device. A conventional personal computer can be used as measurement device for the output signals for example, via the printer interface of which the digital data is read out from the processing electrics to be tested. This requires the time-discrete output signals of the processing electronics to be adapted to the timing of the execution sequences of the computer. This adaptation requires amplitude, impedance and speed adaptations of the input interface. Optionally, instead of the printer interface, faster, PC plug-in cards can also be used which can convert parallel digital inputs in the microsecond range. Furthermore commercially-available logic analyzers can be used as an analysis unit of digital serial or parallel output signals of the processing electronics, especially of detector amplifiers. Agilent offers such a logic analyzer with its model 16702 for example.

A central problem in carrying out testing with the aid of such apparatus lies in the fact that the test process itself, i.e. the sending out of test signals and the acceptance and further processing of the result data, i.e. the output signals of the processing electronics, must be coordinated with the internal execution sequences of the measurement device, i.e. of the PC, in its timing. This represents a highly complicated process which is all the more difficult to coordinate the more processing electronics units there are to be tested at the same time:

The preferred method is namely measurement over a plurality of channels, meaning between two and more than 1000 channels, simultaneously in a very short time. The measurements are made during a period which can extend from the microsecond range up to relatively long times, namely from 100 seconds up to 24 hours. All this is also to take place with as little drift as possible in order not to corrupt the measurement results. The measured currents are only in the range of femto to micro amperes which further complicates the testing specifically with measurements over a number of channels.

### SUMMARY

An embodiment of the present application is for improving the testing of processing electronics, especially the processing electronics of the type described in greater detail above. Such an improvement especially relates to the effectiveness and/or efficiency of the execution sequence and/or the quality of the test results able to be achieved and/or to the speed of the testing or the number of processing electronics units or subunits of individual processing electronics units able to be tested simultaneously.

Accordingly an apparatus of at least one embodiment comprises at least the following elements:

A processing center which defines test sequences during operation and/or further processes result data from the test sequences,

A scheduler unit linked to the processing center, which during operation, after accepting definitions of the test sequences from the processing center, executes these test sequences independently and which is coupled to a contact apparatus for contacting the processing electronics,

A signal generator, which initiates test signals to the processing logic, and

At least one trigger unit which during operation in real time, synchronizes with each other a start of a test sequence carried out by the scheduler unit and an initiation of the test signals by the signal generator.

Such processing electronics to be tested preferably comprises a detector amplifier of such a detector module, which can be realized as an analog-digital detector amplifier for example. Accordingly the apparatus is then embodied for testing such a detector amplifier.

Similarly, a method of at least one embodiment comprises at least the following:

Definition of test sequences for the processing electronics in a processing center,

Acceptance of definitions of the test sequences from the processing center and independent execution of these test sequences by a scheduler unit connected to the processing center, which is coupled to a contact apparatus for contacting the processing electronics,

Initiation of test signals to the processing logic by a signal generator,

Synchronization of a start of a test sequence executed by the scheduler unit and an initiation of the test signals by the signal generator by means of a trigger unit in real time, and

Optional further processing of result data from the test sequences in the processing center.

Such a method can be carried out by way of an inventive apparatus.

At least one embodiment of the inventive apparatus can be realized entirely or partly in the form of hardware, but it can also comprise software modules operating or able to be operated on one or more processors. Therefore at least one embodiment of the invention also includes a computer product which is able to be loaded directly into a processor of a programmable test system, with program code segments for executing all steps of at least one embodiment of the inventive method if the program product is executed on the test system.

Further especially advantageous embodiments and developments of the invention emerge from the dependent claims and also from the description given below. In this case the method can also be developed in accordance with the dependent claims for the apparatus and in accordance with the information given in the description below and conversely the apparatus in accordance with the method as is specified in greater detail below.

### BRIEF DESCRIPTION OF THE DRAWINGS

The invention is explained once again below in greater detail with reference to the enclosed figures on the basis of example embodiments. In these explanations the same components in different figures are provided with identical reference characters. The figures show:

FIG. 1 a schematic block diagram of a first example embodiment of an inventive apparatus,

FIG. 2 a schematic block diagram of a second example embodiment of an inventive apparatus, and

FIG. 3 a schematic block flow diagram of an embodiment of an inventive method.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

An embodiment of the present application is for improving the testing of processing electronics, especially the processing electronics of the type described in greater detail above. Such an improvement especially relates to the effectiveness and/or efficiency of the execution sequence and/or the quality of the test results able to be achieved and/or to the speed of the testing or the number of processing electronics units or subunits of individual processing electronics units able to be tested simultaneously.

Accordingly an apparatus of at least one embodiment comprises at least the following elements:

A processing center which defines test sequences during operation and/or further processes result data from the test sequences,

A scheduler unit linked to the processing center, which during operation, after accepting definitions of the test sequences from the processing center, executes these test sequences independently and which is coupled to a contact apparatus for contacting the processing electronics,

A signal generator, which initiates test signals to the processing logic, and

At least one trigger unit which during operation in real time, synchronizes with each other a start of a test sequence carried out by the scheduler unit and an initiation of the test signals by the signal generator.

Such processing electronics to be tested preferably comprises a detector amplifier of such a detector module, which can be realized as an analog-digital detector amplifier for example. Accordingly the apparatus is then embodied for testing such a detector amplifier.

Similarly, a method of at least one embodiment comprises at least the following:

Definition of test sequences for the processing electronics in a processing center,

Acceptance of definitions of the test sequences from the processing center and independent execution of these test sequences by a scheduler unit connected to the processing center, which is coupled to a contact apparatus for contacting the processing electronics,

Initiation of test signals to the processing logic by a signal generator,

Synchronization of a start of a test sequence executed by the scheduler unit and an initiation of the test signals by the signal generator by means of a trigger unit in real time, and

Optional further processing of result data from the test sequences in the processing center.

Such a method can be carried out by way of an inventive apparatus.

The processing center can be characterized as a central data processing and/or data generation unit. It can be realized on a computer such as a conventionally configured personal computer, if necessary equipped with the appropriate additional software. The processing center defines test sequences, meaning that it generates them and/or selects them, from a database for example. The definitions of the test sequences are also referred to below as test sequence data.

These types of test sequences or test sequence data can be stored for example in the form of test programs or test program sequences. The processing center can be realized as an integral unit disposed in a housing for example, but it can also comprise a number of units separated functionally and/or spatially from one another, such as processors or parts of processors, which are separated from one another and are only assigned functionally to one another. Data can thus for example be generated on a first computer which defines the test sequences while a second computer is assigned the pure processing of the test result data from the inventive method. Such units are preferably linked to each other via permanent or temporary network-type connections.

The scheduler unit is assigned to this processing center, with said unit, after accepting the necessary information for the test sequences, executing this test sequence autonomously, i.e. independently of the test center. It is coupled, preferably electrically or electronically, to a contact apparatus for contacting the processing electronics, such as via a wired connection.

The signal generator initiates signals to the processing electronics. This can be done directly or also with the assistance of further units which are disposed between the signal generator and processing electronics.

The test sequence which is carried out by the scheduler unit and the initiation of the test signals by the signal generator are synchronized with one another. In accordance with the invention this is done by a trigger unit which carries out a real-time synchronization. The trigger unit in this case is independent of signals from the processing center as soon as all information about the test sequences to be carried out is available from the processing center.

A real-time synchronization means a synchronization of sequences such that the waiting processes within the sequences exhibit a predictable duration. A number of trigger signals can be sent out with the aid of the trigger unit both in the direction of the signal generator and also in the direction of the scheduler unit and it can then be assumed that timing of the actions of the signal generator and the scheduler unit are precisely coordinated or synchronized with one another in their execution. This real-time triggering is completely independent of the processing center and is thus faster and more effective with far more easily predictable test executions than if the test method were to be controlled as previously completely by the processing.

The susceptibility to errors and ineffectivity is markedly reduced: Previously a real-time synchronization was not possible because of the internal program sequences of computers. Now on the other hand, by the decoupling of the definitions of a test sequence from its actual execution by units separated from one another in these execution sequences, this real-time synchronization and a correspondingly simplified method execution sequence are possible for the first time. The final effect produced by this is faster sequences, clearly defined assignments of method sections of the signal generator and the scheduler unit and even the ability to cascade individual test systems which process data in parallel in a time resolution in the microsecond range, meaning that they are able to be digitized.

Thus, with at least one embodiment of the inventive apparatus, a very compact means is provided which specifies clear sequences, through which the system noise of the test desk around the processing electronics is minimized. The effect is to enable in this way the inherent noise, the drift, the linearity and further analog and digital parameters of different processing electronics to be qualified individually. Thus a simultaneous qualification or testing of 100,000 or more channels at a very high signal resolution of 32 bits with a high data rate of for example 850 Mbit per second or even more is made possible. This produces a very precise and at the same time rapid measurement. The analog resolution of the individual measurement channels thus extends without any problem from noise in the femtoampere range up to measurement signals in the microampere range.

At least one embodiment of the inventive apparatus can be realized entirely or partly in the form of hardware, but it can also comprise software modules operating or able to be operated on one or more processors. Therefore at least one embodiment of the invention also includes a computer product which is able to be loaded directly into a processor of a programmable test system, with program code segments for executing all steps of at least one embodiment of the inventive method if the program product is executed on the test system.

Further especially advantageous embodiments and developments of the invention emerge from the dependent claims and also from the description given below. In this case the method can also be developed in accordance with the dependent claims for the apparatus and in accordance with the information given in the description below and conversely the apparatus in accordance with the method as is specified in greater detail below.

In accordance with a first embodiment the scheduler unit comprises a programmable memory unit, especially an FPGA. Such an FPGA (Field Programmable Gate Array) is an integrated circuit into which a logic circuit can be programmed. Definitions of test sequences or a program command structure representing the test sequences can be stored by the processing center in the FPGA or another programmable memory unit. This enables the test sequences to be run from the processing center, coordinated by the trigger unit independently and without further input of data from the processing center. An FPGA is a readily obtainable standard chip and is thus especially suitable for the schedule unit: The prerequisites for an independently-operating scheduler unit can be provided with this chip in an uncomplicated manner and without higher costs and provision expense.

To enable the complete independence of the scheduler unit from the processing center during the execution of the testing of the processing electronics to be ensured, it is preferred that the scheduler unit be connected to a power supply independent of the processing center. A battery can serve this purpose for example or a standard power pack, such as a 5V standard power pack, which supplies the scheduler unit separately with power and thereby makes it autonomous during the test sequence. Other types of power supply, for example a different mains supply or another type of power storage, can be used in this context.

As regards the signal generator, it is especially advantageous for this to be connected to a signal issuing unit. The signal issuing unit is embodied so that it issues signals directly to the processing electronics, whereas the signal generator only delivers control commands or information for this. In other words a further separate apparatus is connected between the signal generator and the processing electronics which specifically transmits signals generated by said unit to the processing electronics.

Such signals can be electrical or electronic signals for example which are injected directly via an electrical wired connection into the processing electronics. It is preferred that the signal issuing unit includes a source for electromagnetic radiation, especially a light source. Such a light source can for example comprise a number of LEDs.

During emission of electromagnetic radiation the processing electronics is indirectly supplied with signals: This is based on the same principle as a result of which the detector module functions later during operation of a computer tomograph: Waves are converted by the detector module into electrical charges, so that the processing electronics can further process or pass on the electrical charges in the form of electrical or electronic signals. During operation x-rays are sent to the detector module. There they are either converted directly into charge or are first converted into light radiation in the visible range by way of a scintillation layer and then converted in their turn into charges by way of a photocell. Since the transmission of x-rays to the detector module is associated with relatively high outlay and safety problems, it is especially preferred that the electromagnetic waves comprise light waves (in the visible and/or non-visible range). Thus the conversion of x-rays into light radiation is bypassed and the light signals are injected directly into the detector module. However it is in principle conceivable to beam x-rays or radiation of other wavelengths onto the detector module and have them converted accordingly. This is especially the case if the detector module is embodied so that in operation such electromagnetic radiation or such electromagnetic waves are converted directly into electrical charges without the detour of a conversion into light.

In particular it is preferred in this context for at least the contact apparatus, preferably also other components which are directly connected to signal generation and the acceptance of the test signals, to be housed in a light-tight housing. A light-tight housing in this context is defined as a housing that effectively shields the electromagnetic waves directed onto the detector module or onto the processing electronics from the outside world, with this being understood as a shielding of at least 80% to the outside or from the outside inwards, especially preferably at least 95%.

Such a housing serves on the one hand to protect operators from undesired radiation influences. On the other hand it has the effect of not allowing light or other radiation to enter into the detector module or into the processing electronics accidentally, which would falsify the test results to a significant degree. Such a housing enclosure can thus also be sensible if, instead of signals in the form of electromagnetic waves, direct electrical signals are issued to the processing electronics. In this case too light entering the detector module can lead to an additional generation of charge carriers in the processing electronics which could significantly falsify the measurement result.

It is further preferred that the contact apparatus be connected to a power supply unit for supplying the processing electronics with operating power. Such power supply units are marketed for example by Hameg under the name “Programmable Power Supply HM 7044”. Such a power supply unit can also be embodied as an autonomous unit similar to the power supply of the scheduler, meaning for example as a battery or as an independent power pack, it is however especially preferred for the power supply unit to be controlled by the processing center. This means that the processing center provides the necessary power supply and/or will regulate the power supply unit for example. Since the contact apparatus itself does not define or execute its own program sequences, but this is done by the scheduler unit, the trigger unit and the signal generator, it is not absolutely necessary for the contact apparatus to be autonomous in its power supply.

Test results have shown that, because of the test sequence executed independently by the scheduler unit, the signal generator and the trigger unit, there is no particular requirement for a fast data connection between the processing center and the scheduler unit. Instead test result data can be stored temporarily in the scheduler unit, in the form of data packets for example, and then fed into the central processing unit for further evaluation. A simple, standardized interface is then especially preferably used between the processing center and the scheduler unit. In this context it has transpired that the use of an Ethernet interface connecting the processing center to the scheduler unit is especially advantageous since it is simple to establish (or is already usually present) and to check. Other similar types of interface, especially other personal computer standard interfaces can also basically be used, in which case these depend respectively on the embodiment of the test sequence and the remaining hardware and are therefore to be tailored to the hardware.

As regards the trigger unit this can typically involve a simple trigger socket, but it can also be realized at least partly by software, as mentioned above. In particular provision is to be made in this case for the trigger unit to comprise what is known as a trigger IN/OUT unit, especially preferably such a unit with a number, for example four, input and/or output channels in each case. It is then embodied so that it synchronizes the start of the test sequence and the initiation of the test signals with one another such that both a start of the test sequence causes the initiation of the test signals and also initiation of the test signals causes the start of the test sequence. Thus for example a signal from the scheduler unit which indicates that the test sequence is to be started can be used by the trigger unit to activate the signal generator. The other way round a signal of the signal generator that indicates that these test signals are being issued to the processing electronics can be used to activate the start of the test sequence with the aid of the scheduler unit.

In principle it is possible to test an individual processing electronics unit by itself via a single contact apparatus. The inventive embodiment of the apparatus however also offers the option, and this is especially preferred, of a number of processing electronics units being tested at the same time, i.e. of a cascading of individual test modules being connected, which each testing at least one processing electronics unit practically simultaneously.

In this case there is preferably provision for the apparatus to have a number of contact apparatuses which are each connected to the processing center. For this purpose trigger signals can be forwarded via a number of trigger units, wherein each contact apparatus is then preferably assigned a trigger unit.

The apparatus thus advantageously comprises principally, but particularly if a plurality of contact apparatuses is present, a plurality of trigger units. The end effect is that this makes it possible to execute a test sequence for a number of processing electronics units in a number of contact apparatuses. This is done with the aid of a synchronization of the test sequences with the respective initiations of test signals to this number of processing electronics units. For this purpose trigger signals can be passed on from one trigger unit to the next, wherein preferably, except for one trigger unit at the most, all trigger units are embodied as trigger IN/OUT units.

This means that it is possible to embody the last trigger unit in the series of trigger units—generally speaking exactly one trigger unit—so that it synchronizes the start of the test sequence and the initiation of the test signals with one another in such a way that it either causes the initiation of the test signals at a start of a test sequence or an initiation of the test signals causes the start of the test sequence. This special trigger unit thus involves a pure trigger IN unit without an output channel, which only processes input signals and does not generate any output signals.

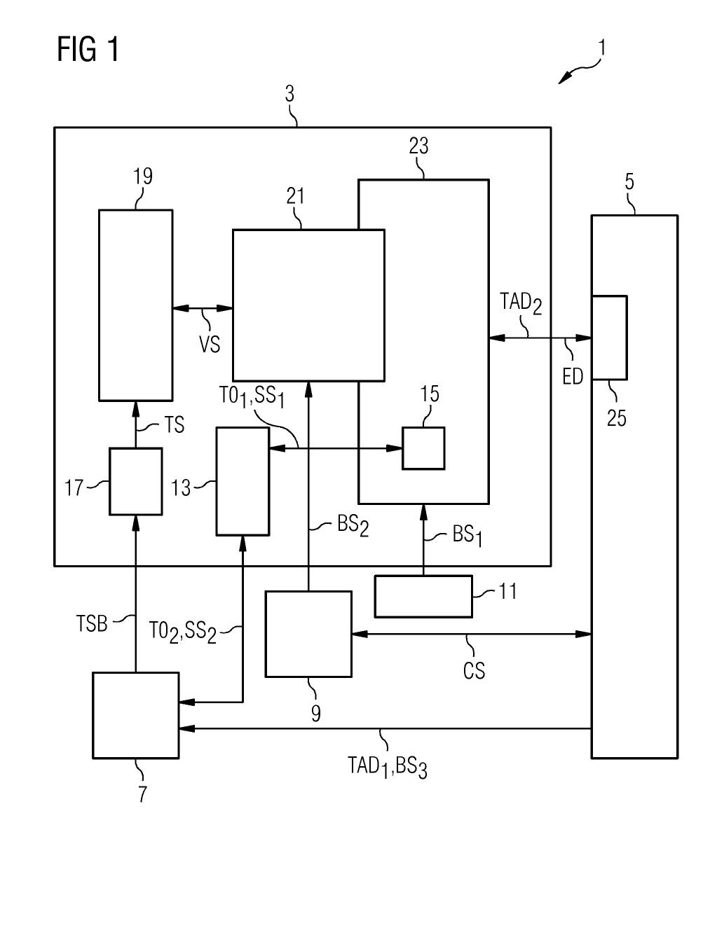

FIG. 1 shows an apparatus 1 for testing processing electronics, here a detector amplifier 19, of a detector module of a computer tomograph. The apparatus 1 comprises a processing center 5, realized here as a personal computer with corresponding additional software. The processing center 5 is connected via an Ethernet interface 25 to components 19, 21, 23, which are located within a light-tight housing 3.

The first of these components 23 is a scheduler unit 23, comprising an FPGA 15. The scheduler unit 23 is electrically connected to a second component, a contact apparatus 21, with which processing electronics 19 to be tested as a third component is contacted. The scheduler unit 23 is assigned a trigger unit 13 which is also linked to a signal generator 7. The trigger unit 13 synchronizes the actions of the signal generator 7 and the scheduler unit 23.

The signal generator 7 is also connected to the processing center 5 and receives from the latter first test sequence data TAD1. From this it generates test signal commands TSB, which it sends to a signal issuing unit 17 which is positioned within the housing 3. The signal issuing unit 17 comprises a light source and, as test signals TS, sends electromagnetic waves in the form of visible light to the processing electronics 19 or to a detector module (not shown) connected to the processing electronics 19. The detector module generates from the optical test signals TS charge carriers, which the processing electronics 19 converts into amplifier signals VS. The amplifier signals VS are injected by the contact apparatus 21 into the scheduler unit 23. The scheduler unit 23 receives via the Ethernet interface 25 from the processing center 5 second test sequence data TAD2, which can comprise the same test sequence data TAD1 that the signal generator 7 also receives. In any event the first and the second test sequence data TAD1, TAD2 correspond to each other in their content, meaning that they can be complementary to one another or are at least partly identical, while other parts of the respective test sequence data TAD1, TAD2 can be different and comprise specific content for the signal generator 7 or the scheduler unit 23 respectively.

The scheduler unit 23 is supplied with operating power BS1 independently by a power supply 11 in the form of a 5V standard power pack. The contact apparatus 21 is supplied with operating power BS2 via a further power supply unit 9, which is controlled by a control signals CS from the processing center 5. The signal generator 7 is supplied directly with operating power BS3 from the processing center 5.

As mentioned, the trigger unit 13 is disposed between the scheduler unit 23 and the signal generator 7. It synchronizes the actions of the scheduler unit 23 and the signal generator 7. This means that the scheduler unit 23 passes on first start signals SS1 to the trigger unit 13 which signal when the scheduler unit 23 is starting the initiation of the test sequence. As an alternative or in addition, the signal generator 7 sends to the trigger unit 13 second start signals SS2, which signal when the signal generator 7 is starting to initiate test signals TS into the processing electronics 19. The trigger unit 13 generates trigger signals TO2 from the first start signals SS1, which are sent for real-time triggering of the initiation of the test signals TS (indirectly) to the signal generator 7. Conversely the trigger unit 13 generates trigger signals TO1 from the second start signals SS2, which are sent for real-time triggering of the start of the test sequence to the scheduler unit 23. Thus the actions of the signal generator 7 and the scheduler unit 23 are synchronized in real time.

The end effect of this arrangement is that the actual test sequence can be controlled and executed by the trigger unit 13 entirely independently of further inputs from the processing center 5, purely on the basis of the autonomous actions of the scheduler unit 23 and the signal generator 7. Only the test sequence data TAD1, TAD2 for the signal generator 7 or the scheduler unit 23 must be obtained from the processing center 5. As soon as this test sequence data TAD1, TAD2 is available there, the test sequence executes independently of the processing center 5. The end effect of this is that result data ED is then generated in the scheduler unit 23, which in its turn is forwarded via the Ethernet interface 25 to the processing center 5 and can be eventually process or analyzed there. This means that the first task and purpose of the processing center 5, is to define a suitable test sequence in advance and appropriately forward the corresponding test sequence data TAD1, TAD2 to the signal generator 7 or to the FPGA 15 of the scheduler unit 23. Secondly it processes the result data ED subsequent to the testing and evaluates said data.

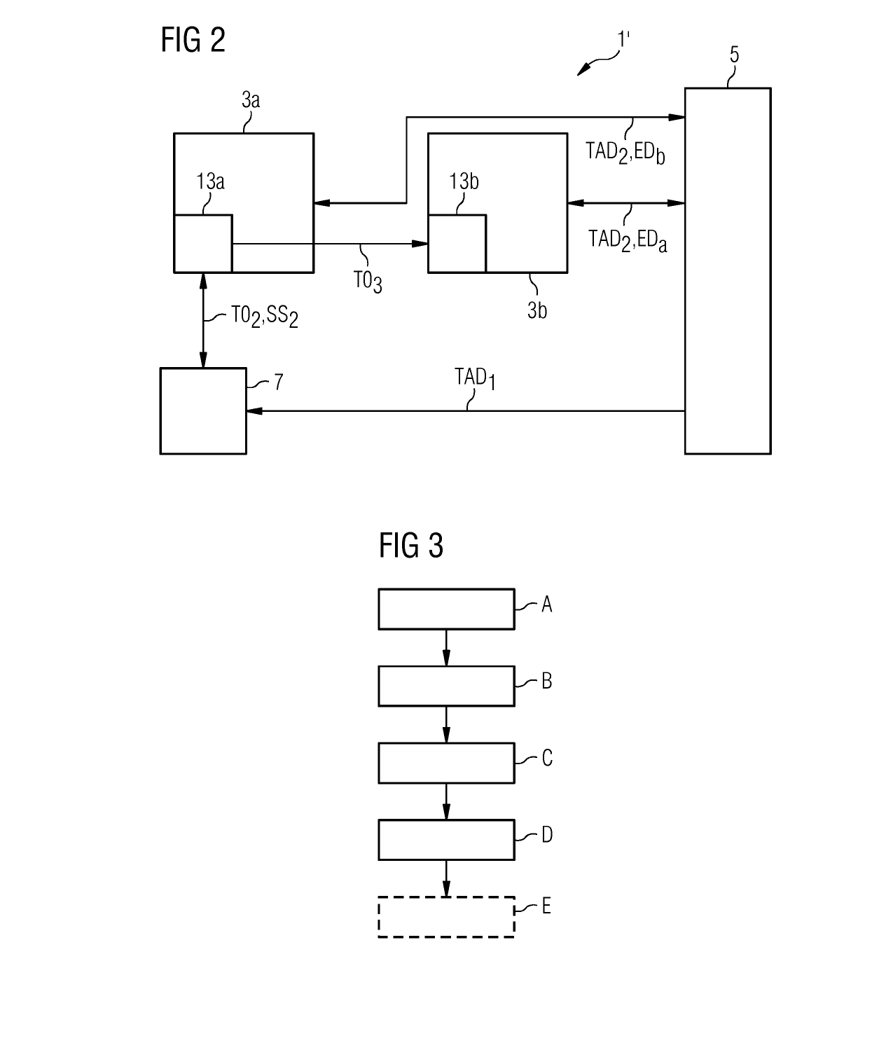

FIG. 2 shows, in a greatly simplified form, a second embodiment of an inventive apparatus 1′. Once again it comprises a processing center 5, a signal generator 7 and a plurality of light-tight housings 3a, 3b, here by way of example two housings 3a, 3b. For the sake of clarity power supplies, as are shown in FIG. 1, are not shown in this figure too. Disposed in the two housings 3a, 3b are components (not shown) similar to the components shown in FIG. 1. This means that in particular a scheduler unit 23 and a contact apparatus 21 are disposed in each housing 3a, 3b. In addition a signal issuing unit 17 is housed in a light-tight manner in each housing 3a, 3b and is connected to the signal generator 7 via a separate connection.

It can be seen from FIG. 2 that each housing 3a, 3b, and thereby each scheduler unit 23 or contact apparatus 21, is assigned a trigger unit 13a, 13b. The housings 3a, 3b and their components are connected to each other by the trigger units 13a, 13b and the test sequences within them can be synchronized with each other in real time by the trigger units 13a, 13b. Each of the two housings 3a, 3b or their scheduler unit contained within them is also connected to the processing center 5.

The processing center 5 for its part sends test sequence data TAD2 to the individual scheduler units 23 in the housings 3a, 3b and receives individual result data EDa, EDb after execution of the tests from the individual housings 3a, 3b from their respective scheduler units 23, which includes or represents the test results of the tests of the processing electronics 19 tested in the housings in each case. Likewise the processing center 5, in a similar manner to the description given in conjunction with FIG. 1, sends test sequence data TAD1 to the signal generator 7. This generator obtains tests signal commands TSB (not shown) from said data and sends these tests signal commands TSB to each of the two signal issuing units 17 in the two housings 3a, 3b. The signal issuing units 17 respectively convey test signals TS in their housings 3a, 3b to processing electronics 19 contacted there by the contact apparatuses 21.

For synchronization of the test sequences and the initiation of test signals TS in the individual housings 3a, 3b on the one hand and for synchronization of theses sequences between the two housings 3a, 3b, start signals SS2 are issued in their turn by the signal generator 7 to the first trigger unit 13a in the first housing 3a. From these, the first trigger unit 13a, which is embodied as an IN/OUT trigger unit 13a, generates trigger signals TO3, which it forwards to the second trigger unit 13b in the second housing 3b. This second trigger unit 13b is embodied as a pure IN trigger unit 13b. The ultimate effect of this is that in this way an independent test of the processing electronics 19 is undertaken in the respective housings 3a, 3a between the individual scheduler units 23 in the housings 3a, 3b via the two trigger units 13a, 13b in conjunction with the signal generator 7 after the test sequence data TAD1, TAD2 has been received from the processing center 5.

The circuit shown in FIG. 2 is thus based on the principle of cascading. In the present case only two housings 3a, 3b are shown, but of course (and preferably) a larger plurality of individual units for testing processing electronics can be disposed one after the other.

FIG. 3 shows a schematic block diagram of a sequence of an inventive method for testing processing electronics 19 which will now be explained in greater detail against the background of the information depicted in FIG. 1.

In a first step A test sequences are defined for the processing electronics 19 in the processing center 5. In a second step B definitions of the test sequences are accepted from the processing center 5 and executed independently of the processing center 5 by the scheduler unit 23. For this purpose, in a step C, the signal generator 7 introduces test signals TS into the processing electronics 19. The two steps B and C are synchronized with each other in this way in real time in a synchronization step D. This guarantees that the start of the test sequence executed by the scheduler unit 23 and the initiation of the test signals TS by the signal generator 7 are coordinated fully comprehensively with one another and thereby are tailored to each other in terms of their timing in the optimum way. Optionally, in a step E, further processing of result data ED from the test sequences can be undertaken in the processing center 5.

In conclusion it is pointed out once again that the components of the apparatus or of its individual components described in detail above merely involve exemplary embodiments which are able to be modified by the person skilled in the art in a very wide variety of ways without departing from the field of the invention. Furthermore the use of the indefinite article “a” or “an” does not preclude the features concerned also being able to be present a number of times. In addition “units” can consist of one or more components, even disposed spatially separated.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An apparatus for testing processing electronics, comprising:
a processing center, to at least one of define test sequences during operation and further processes result data from the test sequences;
a scheduler unit, operatively connected to the processing center, to, during operation and after accepting definitions of the test sequences from the processing center, execute the test sequences independently, the scheduler unit further being operatively coupled to a contact apparatus for contacting the processing electronics;
a signal generator, to initiate test signals to the processing electronics; and
at least one trigger unit to, during operation in real time, synchronize a start of a test sequence carried out by the scheduler unit and an initiation of the test signals by the signal generator.

2. The apparatus of claim 1, wherein the scheduler unit comprises a programmable memory unit.

3. The apparatus of claim 1, wherein the scheduler unit is connected to a power supply independent of the processing center.

4. The apparatus of claim 1, wherein the signal generator is connected to a signal issuing unit.

5. The apparatus of claim 4, wherein the signal issuing unit comprises a source for electromagnetic radiation.

6. The apparatus of claim 1, wherein the contact apparatus is connected to a power supply unit to supply the processing electronics with operating power.

7. The apparatus of claim 6, wherein the power supply unit is controlled by the processing center.

8. The apparatus of claim 1, wherein the contact apparatus is housed in a light-tight housing.

9. The apparatus of claim 1, wherein the processing center and the scheduler unit are connected to each other via an Ethernet interface.

10. The apparatus of claim 1, wherein the trigger unit is embodied to synchronize the start of the test sequence and the initiation of the test signals with one another such that both a start of the test sequence causes the initiation of the test signals and an initiation of the test signals also causes the start of the test sequence.

11. The apparatus of claim 1, wherein the contact apparatus includes a plurality of contact apparatuses.

12. The apparatus of claim 1, wherein the at least one trigger unit includes a plurality of trigger units.

13. The apparatus of claim 12, wherein the plurality of trigger units are embodied to synchronize the start of the test sequence and the initiation of the test signals with one another to either cause the initiation of the test signals when the test sequence is started or have an initiation of the test signals cause the start of the test sequence.

14. A method for testing processing electronics, comprising:
defining test sequences for the processing electronics in a processing center;
accepting definitions of the test sequences from the processing center and independently executing the test sequences via a scheduler unit operatively connected to the processing center, which is operatively coupled to a contact apparatus for contacting the processing electronics;
initiating test signals at the processing electronics via a signal generator; and
synchronizing a start of a test sequence executed by the scheduler unit and an initiation of the test signals by the signal generator via the trigger unit in real time.

15. The method of claim 14, further comprising:
further processing result data from the test sequences in the processing center.

16. A computer program product, loadable directly into a processor of a programmable test system, including program code segments for carrying out the method of claim 15 upon the program product being executed on the programmable test system.

17. The apparatus of claim 1, wherein the apparatus is for testing processing an integrated circuit of a detector module of a computer tomograph.

18. The apparatus of claim 2, wherein the programmable memory unit is an FPGA.

19. The apparatus of claim 5, wherein the source for electromagnetic radiation is a light source.

20. The method of claim 14, wherein the electronics include an integrated circuit of a detector module of a computer tomograph.

21. A computer readable medium including program segments for, when executed on a computer device, causing the computer device to implement the method of claim 14.
